(19) United States
(12) Patent Application Publication
(10) Pub. No.: US 2026/0037866 A1
(43) Pub. Date: Feb. 5, 2026

(54) IMAGE CAPTION GENERATION MODEL LEARNING APPARATUS, IMAGE CAPTION GENERATION APPARATUS, IMAGE CAPTION GENERATION MODEL LEARNING METHOD, IMAGE CAPTION GENERATION METHOD, AND PROGRAM

(71) Applicant: NIPPON TELEGRAPH AND TELEPHONE CORPORATION, Tokyo (JP)

(72) Inventors: Ryo MASUMURA, Tokyo (JP); Akihiko TAKASHIMA, Tokyo (JP); Mana IHORI, Tokyo (JP)

(73) Assignee: NIPPON TELEGRAPH AND TELEPHONE CORPORATION, Tokyo (JP)

(21) Appl. No.: 18/997,002

(22) PCT Filed: Jul. 25, 2022
(86) PCT No.: PCT/JP2022/028616

§ 371 Date: Jan. 18, 2025

(51) Int. Cl. G06N 20/00; G06F 40/169

(52) U.S. Cl. CPC G06N 20/00; G06F 40/169

(57) ABSTRACT

An image caption generation model learning apparatus uses, as inputs, pair data of an image that is learning data for image caption generation and text data that is a caption describing the image and pair data of a first language text and a second language text that are machine translation data; and learns an image parameter that is a model parameter for image hidden information generation, a text parameter that is a model parameter for text hidden information generation, a crossmodal parameter that is a model parameter for crossmodal invariant information embedment, and an output parameter that is a model parameter for text generation.

### TECHNICAL FIELD

The present disclosure relates to an image caption generation model learning apparatus, an image caption generation apparatus, an image caption generation model learning method, an image caption generation method, and a program for learning an image caption generation model for generating a caption describing an image from the image.

### BACKGROUND ART

Image caption generation is a task of generating a caption describing the content of an image as text, and is a technique leading to symbol grounding of an image. In particular, after the advent of deep learning, End-to-End caption generation in which conversion from an image to a text is modeled End-to-End has been actively studied.

The modeling of the End-to-End method in the conventional art is achieved by modeling the generation probability of the output text for the image. As a function for performing image caption generation, any function can be applied as long as the function can directly model the generation probability of the output text for the image. For example, a network combining a recurrent neural network and a convolutional neural network, or a function using Transformer or the like can be used (see, for example, Non Patent Literature 1, Non Patent Literature 2, and Non Patent Literature 3).

### CITATION LIST

### Non Patent Literature

Non Patent Literature 1:0. Vinyals, A. Toshev, S. Bengio, and D. Erhan, “Show and Tell: A neural image caption generator”, In Proc. CVPR, pp. 3156-3164, 2015. Non Patent Literature 2: P. Anderson, X. He, C. Buehler, D. Teney, M. Johnson, S. Gould, and L. Zhang, “Bottom-up and top-down attention for image captioning and visual question answering”, In Proc. CVPR, pp. 6077-6086, 2018. Non Patent Literature 3: S. Herdade, A. Kappeler, K. Boakye, and J. Soares, “Image captioning: Transforming objects into words”, In Proc. NeurIPS, 2019.

### SUMMARY OF INVENTION

### Technical Problem

In the conventional art, since a model is learned by labeled learning data, a large amount of pair data of an image and text serving as a caption is required. In particular, in the problem of image caption generation, it is required to annotate a plurality of captions for each image. However, since such an annotation is very costly, it is difficult to collect a large amount of pair data. Therefore, there is often a problem that desired performance cannot be achieved due to insufficient learning data.

Therefore, an object of the present disclosure is to provide an image caption generation model learning apparatus capable of generating a highly accurate image caption even when learning data including a pair of an image and an output text serving as a caption is small.

### Solution to Problem

An image caption generation model learning apparatus of the present disclosure uses, as inputs, pair data of an image that is learning data for image caption generation and text data that is a caption describing the image and pair data of a first language text and a second language text that are machine translation data; and learns an image parameter that is a model parameter for image hidden information generation, a text parameter that is a model parameter for text hidden information generation, a crossmodal parameter that is a model parameter for crossmodal invariant information embedment, and an output parameter that is a model parameter for text generation.

### Advantageous Effects of Invention

With the image caption generation model learning apparatus of the present disclosure, it is possible to generate a highly accurate image caption even when learning data including a pair of an image and an output text serving as a caption is small.

### BRIEF DESCRIPTION OF DRAWINGS

FIG. 1 is a diagram illustrating an outline of processing of an image caption generation model learning apparatus of Example 1.

FIG. 2 is a block diagram illustrating a functional configuration of the image caption generation model learning apparatus of Example 1.

FIG. 3 is a flowchart illustrating an operation of the image caption generation model learning apparatus of Example 1.

FIG. 4 is a block diagram illustrating a functional configuration of an image caption generation apparatus of Example 1.

FIG. 5 is a flowchart illustrating an operation of the image caption generation apparatus of Example 1.

FIG. 6 is a diagram illustrating a functional configuration example of a computer.

### DESCRIPTION OF EMBODIMENTS

An outline of image caption generation of the End-to-End method will be described below. The input is an image. Since this image is RGB image information and relates to an image with a general extension such as jpg or png, details thereof are omitted here. As described above, the modeling of the End-to-End method in the conventional art is achieved by modeling the generation probability of output text W for an image C. This generation probability can be defined by the formula described below.

$$P ( W \vert C ; θ ) = ImageCaptioning ( C ; θ ) \qquad [ Math . 1 ]$$

Here, W represents a sequence of tokens such as words and characters. ImageCaptioning ( ) is a function for performing image caption generation, and any function can be applied as long as the function can directly model the generation probability of the output text for the image. For example, a network combining a recurrent neural network and a convolutional neural network, or a function using Transformer or the like can be used, and the techniques of Non Patent Literatures 1 to 3 can be adopted.

θ is a parameter calculated in advance by a method to be described below using learning data given in advance, and the entity of the parameter depends on the definition of the function of ImageCaptioning ( ) In the case of performing such modeling, execution of image caption generation for an arbitrary image is based on the formula described below.

$$\hat{W} = {argmax}_{W} P ( W \vert C ; θ ) \qquad [ Math . 2 ]$$

W\hat{ } is a text generated as a caption. Note that “W\hat{ }” is originally correctly written by writing W in italics and adding a circumflex immediately above W, but this cannot be written due to a problem of functions of document creation software and electronic application software, and therefore, for convenience, a circumflex may be added after W in Roman type. Hereinafter, the same applies to other characters.

In the conventional art, the model parameter θ is learned by preparing one or more sets of pair data of an image and an output text serving as a caption. When a learning data set including L (L is an integer of 1 or more) pieces of pair data is set as D={(C₁, W₁), . . . , (C_{L}, W_{L})}, learning is performed according to the criterion described below.

$$\hat{θ} = {argmax }_{θ} {\sum }_{l = 1}^{L} log P ( {W}_{l} \vert {C}_{l} ; θ ) \qquad [ Math . 3 ]$$

Here, θ\hat{ } represents a model parameter learned based on learning data. Note that although this model parameter estimation problem can be solved by an arbitrary method, for example, optimization using a gradient method can be used. For details, see Non Patent Literatures 1 to 3.

In order to solve the problem that a large amount of labeled learning data is required, the present disclosure discloses an image caption generation model learning apparatus and an image caption generation apparatus using machine translation data and paraphrase generation learning data for learning a problem of converting an image into a text.

Machine translation indicates that an input sentence is automatically converted into a sentence in a different language without changing the meaning. In addition, paraphrase generation means that an input sentence is converted into a sentence in the same language and a different expression without changing the meaning.

The key idea of the present disclosure is to take as an approach that these machine translation and paraphrase generation are thought to address problems similar to image caption generation although an input modality is different. Specifically, it is assumed that most components can be shared by designing a function for machine translation or paraphrase generation and designing a function for image caption generation, and a unified function design is performed so that these three types of problems can be handled well. Then, the model parameters of the function are learned using not only the learning data for image caption generation but also machine translation data and paraphrase generation learning data. There is also an advantage that a large amount of machine translation data can be created relatively easily by using information on the WEB.

According to the present disclosure, it is possible to achieve image caption generation with high performance even in a case where the amount of learning data for image caption generation is small by utilizing the machine translation data and the paraphrase generation learning data.

Hereinafter, embodiments of the present disclosure will be described in detail. Note that components having the same functions are denoted by the same reference numerals, and redundant description will be omitted.

### Example 1

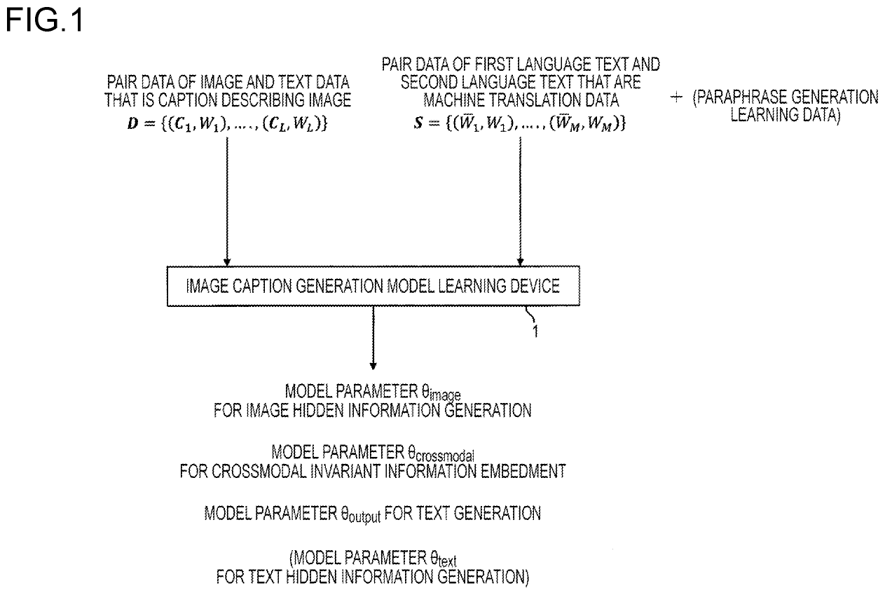

FIG. 1 illustrates an outline of processing of an image caption generation model learning apparatus 1 of Example 1.

### <Image Caption Generation Model Learning Apparatus 1>

Input: Pair data (L, L is an integer of 1 or more) of an image that is learning data for image caption generation and text data that is a caption describing the image.

$$D = \{ ( {C}_{1} , {W}_{1} ) , … , ( {C}_{L} , {W}_{L} ) \} \qquad [ Math . 4 ]$$

Pair data (M, M is an integer of 1 or more) of first language text W⁻ and second language text W, which are the machine translation data, and it is more preferable to include not only the machine translation data but also the paraphrase generation learning data. Since the paraphrase generation learning data can be handled in the same manner as the machine translation data, W⁻ may be replaced with the text before paraphrase conversion and W may be replaced with the text after paraphrase conversion as appropriate.

$$S = \{ ( {\overline{W}}_{1} , {W}_{1} ) , … , ( {\overline{W}}_{M} , {W}_{M} ) \} \qquad [ Math . 5 ]$$

Output: Model parameter θ_{image} for image hidden information generation (hereinafter, image parameter θ_{image}) Model parameter θₜₑₓₜ for text hidden information generation (hereinafter, text parameter θₜₑₓₜ) Model parameter θ_{crossmodal} for crossmodal invariant information embedment (hereinafter, crossmodal parameter θ_{crossmodal})

Model parameter θₒᵤₜₚᵤₜ for text generation (hereinafter, output parameter θₒᵤₜₚᵤₜ) Note that, since the text parameter θₜₑₓₜ is not used in an inference phase, the output is not essential.

The image caption generation model learning apparatus 1 estimates various model parameters from pair data of an image and an output text serving as a caption and pair data of an input text and an output text for machine translation or paraphrase.

Here, for simplification, various model parameters are represented as Θ={θ_{image}, θₜₑₓₜ, θ_{crossmodal}, θₒᵤₜₚᵤₜ}. The image caption generation model learning apparatus 1 estimates these parameters as described below.

$$\hat{Θ} = {argmax}_{Θ} \{ {\sum }_{l = 1}^{L} log P ( {W}_{l} \vert {C}_{l} ; Θ ) + {\sum }_{m = 1}^{M} log P ( {W}_{m} \vert {\overline{W}}_{m} ; Θ ) \} \qquad [ Math . 6 ]$$

Θ\hat{ } represents a model parameter learned based on learning data. Note that although this model parameter estimation problem can be solved by an arbitrary method, for example, optimization using a gradient method can be used.

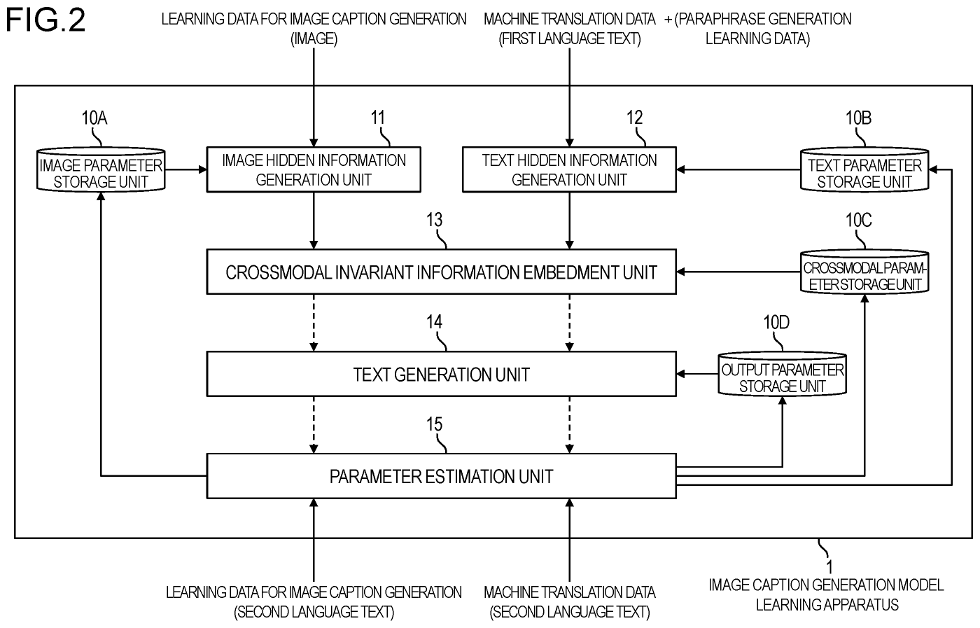

Hereinafter, a functional configuration of the image caption generation model learning apparatus 1 of Example 1 will be described with reference to FIG. 2. As illustrated in the drawing, the image caption generation model learning apparatus 1 of the present example includes an image parameter storage unit 10A, a text parameter storage unit 10B, a crossmodal parameter storage unit 10C, an output parameter storage unit 10D, an image hidden information generation unit 11, a text hidden information generation unit 12, a crossmodal invariant information embedment unit 13, a text generation unit 14, and a parameter estimation unit 15.

### <Image Parameter Storage Unit 10A>

The image parameter storage unit 10A stores the image parameter θ_{image}. The image parameter θ_{image} is optimized by a gradient method or the like, but it is sufficient if an initial value of θ_{image} is stored in the storage unit in the first phase of optimization.

### <Text Parameter Storage Unit 10B>

The text parameter storage unit 10B stores the text parameter θₜₑₓₜ. The text parameter θₜₑₓₜ is optimized by a gradient method or the like, but it is sufficient if an initial value of θₜₑₓₜ is stored in the storage unit in the first phase of optimization.

### <Crossmodal Parameter Storage Unit 10C>

The crossmodal parameter storage unit 10C stores the crossmodal parameter θ_{crossmodal}. The crossmodal parameter θ_{crossmodal} is optimized by a gradient method or the like, but it is sufficient if an initial value of θ_{crossmodal} is stored in the storage unit in the first phase of optimization.

### <Output Parameter Storage Unit 10D>

The output parameter storage unit 10D stores the output parameter θₒᵤₜₚᵤₜ. The output parameter θₒᵤₜₚᵤₜ is optimized by a gradient method or the like, but it is sufficient if an initial value of θₒᵤₜₚᵤₜ is stored in the storage unit in the first phase of optimization.

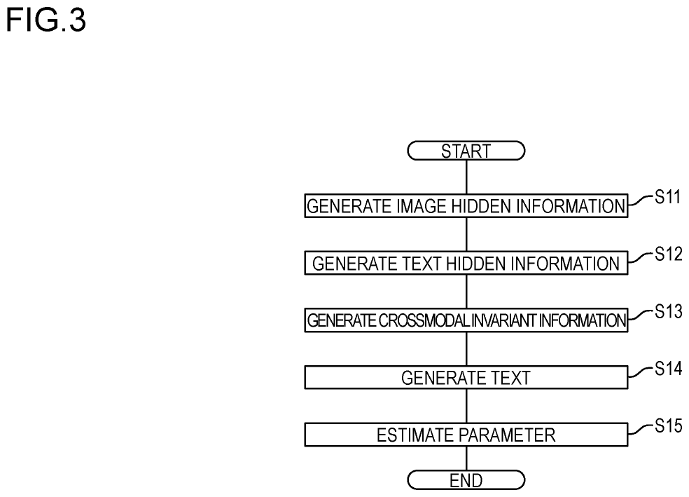

Hereinafter, the operation of each component will be described with reference to FIG. 3.

### <Image Hidden Information Generation Unit 11>

Input: Image C, image parameter θ_{image}
Output: Image hidden information H

The image hidden information generation unit 11 generates the image hidden information H from the image C and the image parameter θ_{image} (S11). As in the conventional art, since the image is RGB image information and relates to an image with a general extension such as jpg or png, details thereof are omitted here. The image hidden information H can be estimated according to the formula described below.

$$H = Image 2 Hidden ( C ; {θ}_{i m a g e} ) \qquad [ Math . 7 ]$$

Here, the image hidden information H is information represented as a vector sequence, and depends on design of a function of Image2Hidden ( ) Image2Hidden ( ) is a function that converts an image into image hidden information. For this function, any network can be used as long as the learning criterion related to the image parameter image can be applied, and for example, a convolutional neural network or the like can be used.

### <Text Hidden Information Generation Unit 12>

Input: First language text W⁻, text parameter θₜₑₓₜ
Output: Text hidden information Q

The text hidden information generation unit 12 generates the text hidden information Q from the first language text W⁻ and the text parameter θₜₑₓₜ (S12). Here, the first language text W⁻ is a sequence of tokens such as words and characters, and is assumed to be a language text of a translation destination or a translation source of machine translation data. For example, the first language text is English, Japanese, or the like. The second language text paired with the first language text is a language text of a translation source or a translation destination. For example, the second language text is Japanese, English, or the like. When learning data for paraphrase generation is input, W⁻ is replaced with the text before paraphrase conversion, and the same processing is executed.

The text hidden information Q can be estimated according to the formula described below.

$$Q = Text 2 Hidden ( \overline{W} ; {θ}_{t e x t} ) \qquad [ Math . 8 ]$$

Here, the text hidden information Q is information represented as a vector sequence, and depends on design of a function of Text2Hidden. Text2Hidden is a function that converts the first language text into text hidden information. For this function, any network can be used as long as the learning criterion related to the text parameter θₜₑₓₜ can be applied, and for example, a convolutional neural network or the like can be used.

### <Crossmodal Invariant Information Embedment Unit 13>

Input: Image hidden information H or text hidden information Q, crossmodal parameter θ_{crossmodal}
Output: Inter-crossmodal invariant information U

The crossmodal invariant information embedment unit 13 generates the inter-crossmodal invariant information U from the image hidden information H or the text hidden information Q and the crossmodal parameter θ_{crossmodal} (S13). The inter-crossmodal invariant information U is generated by the formula described below.

$$U = Hidden 2 Crossmodal ( H ; {θ}_{crossmodal} ) \qquad [ Math . 9 ]$$

$$or$$

$$U = Hidden 2 Crossmodal ( Q ; {θ}_{crossmodal} ) \qquad [ Math . 10 ]$$

Here, the inter-crossmodal invariant information U is information represented as a vector sequence, and depends on design of functions of Image2Hidden ( ) described above, Hidden2Crossmodal ( ), and Text2Hidden ( ). Hidden2Crossmodal ( ) is a function that converts image hidden information into inter-crossmodal invariant information. In addition, at the same time, there is a function capable of converting the text hidden information into the inter-crossmodal invariant information. Specifically, any network can be used as long as the learning criterion related to the crossmodal parameter θ_{crossmodal} can be applied, and for example, a recurrent neural network, Transformer, or the like can be used.

### <Text Generation Unit 14>

Input: Inter-crossmodal invariant information U, output parameter θₒᵤₜₚᵤₜ
Output: Text

The text generation unit 14 generates a text generation probability P(W|C) or P(W|W⁻) from the inter-crossmodal invariant information U and the output parameter θₒᵤₜₚᵤₜ, and generates a text serving as a caption of an image or a text that is an output of machine translation (or paraphrase conversion) (S14). The estimation of the text generation probability P(W|C) or P(W|W⁻) follows the formula described below.

$$P ( W \vert C ) = Crossmodal 2 Text ( U ; {θ}_{output} ) \qquad [ Math . 11 ]$$

$$or$$

$$P ( W \vert \overline{W} ) = Crossmodal 2 Text ( U ; {θ}_{output} ) \qquad [ Math . 12 ]$$

Crossmoda12Text ( ) is a function for calculating a posterior probability of a text from a vector sequence. As this function, any network can be used as long as the learning criterion related to the output parameter θₒᵤₜₚᵤₜ can be applied, and for example, this function can be achieved by combining a recurrent neural network, Transformer, and a softmax function. By using this text generation probability, image caption generation, text generation by machine translation, or text generation by paraphrase generation can be performed on the basis of the formula described below.

$$\hat{W} = {argmax}_{W} P ( W \vert C ) \qquad [ Math . 13 ]$$

$$or$$

$$\hat{W} = {argmax}_{W} P ( W \vert \overline{W} ) \qquad [ Math . 14 ]$$

### <Parameter Estimation Unit 15>

Input: Learning data for image caption generation (image, second language text)
Machine translation data (first language text, second language text)
Or paraphrase generation learning data (text before conversion, text after conversion).
Output: various model parameters Θ={θ_{image}, θₜₑₓₜ, θ_{crossmodal} θₒᵤₜₚᵤₜ}

The parameter estimation unit 15 uses the set of the image C that is the learning data for image caption generation and the corresponding second language text W and the set of the first language text W⁻ that is the machine translation data and the corresponding second language text W (and paraphrase generation learning data), and estimates the various model parameters Θ={θ_{image}, θₜₑₓₜ, θ_{crossmodal}, θₒᵤₜₚᵤₜ} such that the sum of the text generation probability of the text corresponding to the caption, the translation result of the machine translation, and the text generation probability of the text corresponding to the paraphrase generation result becomes maximum by the formula described above (S15).

$$\hat{Θ} = {argmax}_{Θ} \{ {\sum }_{l = 1}^{L} log P ( {W}_{l} \vert {C}_{l} ; Θ ) + {\sum }_{m = 1}^{M} log P ( {W}_{m} \vert {\overline{W}}_{m} ; Θ ) \} \qquad [ Math . 15 ]$$

Note that each text generation probability P in the two terms in argmax of the above formula is generated in step S14.

Although the parameter estimation unit 15 can solve the model parameter estimation problem by an arbitrary method, for example, optimization using a gradient method can be used.

### Example 2

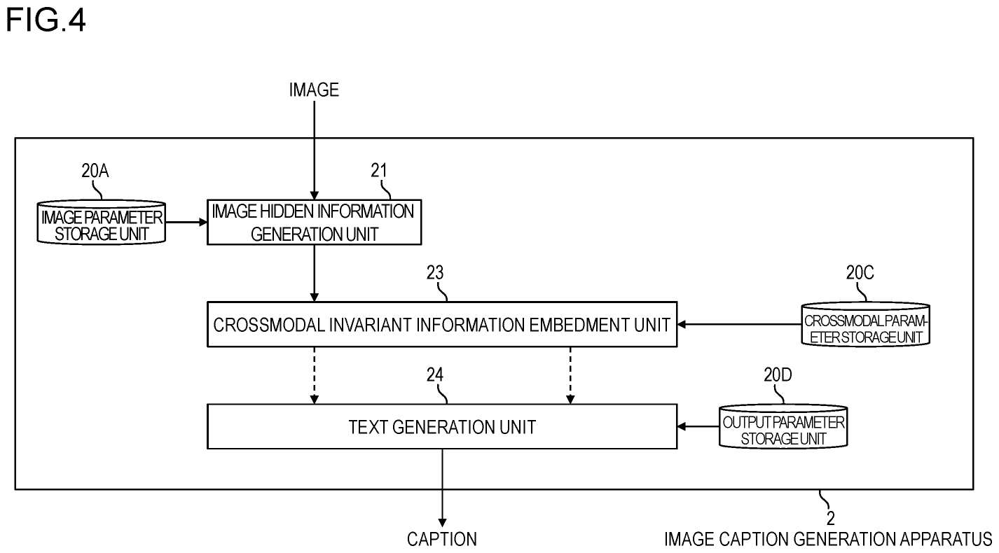

Hereinafter, a functional configuration of an image caption generation apparatus 2 of Example 2 that generates a caption corresponding to an image using an image as an input on the basis of model parameters learned by the image caption generation model learning apparatus 1 of Example 1 will be described with reference to FIG. 4.

As illustrated in the drawing, the image caption generation apparatus 2 of the present example includes an image parameter storage unit 20A, a crossmodal parameter storage unit 20C, an output parameter storage unit 20D, an image hidden information generation unit 21, a crossmodal invariant information embedment unit 23, and a text generation unit 24.

### <Image Parameter Storage Unit 20A>

The image parameter storage unit 20A stores the image parameter θ_{image} optimized by the image caption generation model learning apparatus 1.

### <Crossmodal Parameter Storage Unit 20C>

The crossmodal parameter storage unit 20C stores the crossmodal parameter θ_{crossmodal} optimized by the image caption generation model learning apparatus 1.

### <Output Parameter Storage Unit 20D>

The output parameter storage unit 20D stores the output parameter θₒᵤₜₚᵤₜ optimized by the image caption generation model learning apparatus 1.

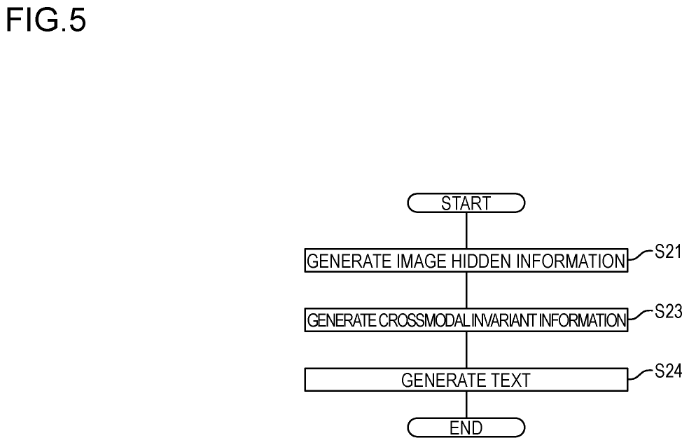

Hereinafter, the operation of each component will be described with reference to FIG. 5.

### <Image Hidden Information Generation Unit 21>

Input: Image C, image parameter θ_{image}
Output: Image hidden information H

The image hidden information generation unit 21 generates the image hidden information H from the image and the image parameter θ_{image} (S21).

### <Crossmodal Invariant Information Embedment Unit 23>

Input: Image hidden information H, crossmodal parameter crossmodal
Output: Inter-crossmodal invariant information U

The crossmodal invariant information embedment unit 23 generates the inter-crossmodal invariant information U from the image hidden information H and the crossmodal parameter θ_{crossmodal} (S23).

### <Text Generation Unit 24>

Input: Inter-crossmodal invariant information U, output parameter θₒᵤₜₚᵤₜ
Output: Output text W

The text generation unit 24 generates a text generation probability P(W|C) from the inter-crossmodal invariant information U and the output parameter θₒᵤₜₚᵤₜ, and generates a text W serving as a caption of an image (S24).

### <Comparison by Evaluation Index>

Scores according to BLEU-4, METEOR, and CIDEr were calculated for four patterns of conditions: a case where both the paraphrase generation learning data and the machine translation data were not used (expressed as baseline), a case where only the paraphrase generation learning data was added (expressed as +paraphrase), a case where only the machine translation data was added (expressed as +machine translation), and a case where the paraphrase generation learning data and the machine translation data were combined (expressed as +paraphrase+machine translation). Note that the model structure was transformer-encoder 2 layers+transformer-decoder 2 layers, and the data amounts used were the pair data amount of image captions=40,000, the pair data amount of paraphrase generation=1,465,740, and the data amount of Japanese to English machine translation=2,000,000. The score calculation results are indicated in the table described below.

TABLE 1

| Method | BLEU-4 | METEOR | CIDEr |
|---|---|---|---|
| Baseline | 0.290 | 0.253 | 0.926 |
| +paraphrase | 0.305 | 0.257 | 0.966 |
| +machine translation | 0.308 | 0.259 | 0.972 |
| +paraphrase | 0.312 | 0.261 | 0.980 |
| +machine translation | | | |

It can be seen that the score is the highest when the paraphrase generation learning data and the machine translation data are combined (+paraphrase+machine translation) in any of the methods BLEU-4, METEOR, and CIDEr. In addition, in any of the methods, between the case where only the paraphrase generation learning data is added and the case where only the machine translation data is added, it is found that the score is higher in the case where only the machine translation data is added.

The image caption generation model learning apparatus 1 of Example 1 and the image caption generation apparatus 2 of Example 2 have an additional element of using the machine translation data for learning of the image caption generation model with respect to a conventional system, and this additional element enumerates a specific method capable of generating a highly accurate image caption even with a small amount of learning data with respect to the conventional system, and as a result, provides reduction in the amount of calculation by the computer and improvement in the estimation accuracy by the computer.

### <Supplementary Notes>

The device according to the present disclosure includes, for example, as a single hardware entity, an input unit that can be connected to a keyboard or the like, an output unit that can be connected to a liquid crystal display or the like, a communication unit that can be connected to a communication device (e.g., a communication cable) capable of communicating with the outside of the hardware entity, a central processing unit (CPU which may include a cache memory or a register), RAM or ROM, which is a memory, an external storage device as a hard disk, and a bus that connects the input unit, the output unit, the communication unit, the CPU, the RAM, the ROM, and the external storage device so that data can be exchanged therebetween. In addition, if necessary, a device (drive) or the like that can read and write a recording medium such as a CD-ROM may be provided in the hardware entity. Examples of a physical entity including such a hardware resource include a general-purpose computer.

The external storage device of the hardware entity stores a program required to implement the above-described functions, data required to process the program, and the like (it is not limited to the external storage device and the program may be stored, for example, in ROM, which is a read-only storage device). In addition, such data or the like obtained by the processing by the program is appropriately stored in the RAM, the external storage device, or the like.

In the hardware entity, each program stored in the external storage device (or ROM or the like) and data required for processing of each program are read into a memory as necessary and are appropriately interpreted, executed, and processed by the CPU. As a result, the CPU implements a predetermined function (each component represented as . . . unit, . . . means, or the like).

The present disclosure is not limited to the above-described embodiment, and modifications can be made without departing from the gist of the present disclosure as appropriate. In addition, the pieces of processing described in the foregoing embodiment may be executed not only chronologically in accordance with the described order, but also in parallel or individually in accordance with the processing capability of a device that executes the processing or as necessary.

As described earlier, in a case where the processing functions of the hardware entity (the device according to the present disclosure) described in the foregoing embodiment are implemented by a computer, processing contents of the functions that the hardware entity are supposed to have are described by a program. The computer then executes this program, whereby the processing functions of the hardware entity are implemented in the computer.

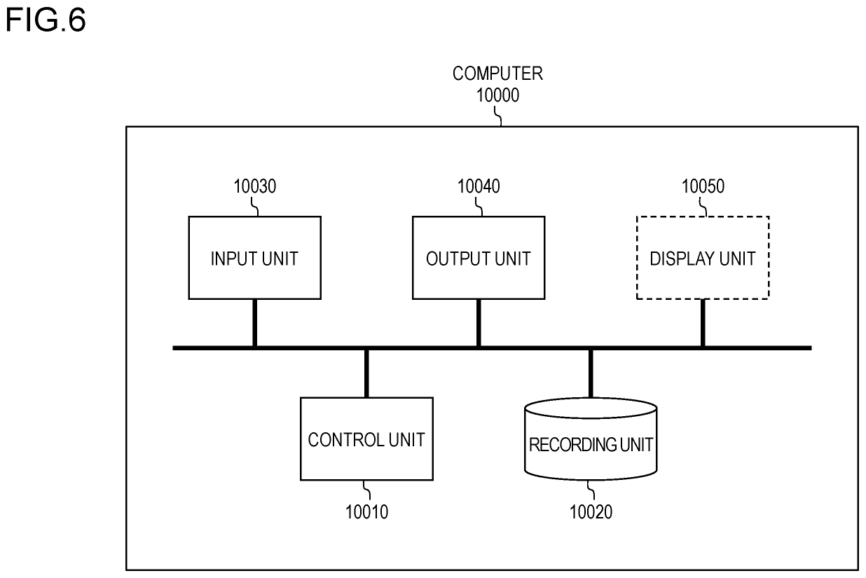

Various types of processing described above can be carried out by causing a recording unit 10020 of a computer 10000 illustrated in FIG. 6 to read the program for executing each step of the method described above and causing a control unit 10010, an input unit 10030, an output unit 10040, and the like to operate.

The program in which the processing contents are described can be recorded on a computer-readable recording medium. The computer-readable recording medium may be, for example, any recording medium such as a magnetic recording device, an optical disc, a magneto-optical recording medium, or a semiconductor memory. Specifically, for example, a hard disk device, a flexible disk, a magnetic tape, or the like can be used as the magnetic recording device, a digital versatile disc (DVD), DVD random access memory (DVD-RAM), a compact disc read only memory (CD-ROM), a CD recordable/rewritable (CD-R/RW), or the like can be used as the optical disc, a magneto-optical disc (MO) or the like can be used as the magneto-optical recording medium, and electrically erasable and programmable-read only memory (EEP-ROM) or the like can be used as the semiconductor memory.

In addition, the program is distributed by, for example, selling, transferring, or renting a portable recording medium such as a DVD or CD-ROM in which the program is recorded. Further, the program may be stored in a storage device of a server computer and be distributed by transferring the program from the server computer to another computer via a network.

For example, a computer that executes such a program first temporarily stores a program recorded on a portable recording medium or a program transferred from a server computer in a storage device of its own. Then, when executing processing, the computer reads the program stored in the recording medium of its own and executes the processing according to the read program. In addition, as another mode of executing the program, the computer may read the program directly from the portable recording medium and execute the processing according to the program, or may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program in the present mode includes information that is used for processing by an electronic computing machine and is equivalent to the program (data or the like that is not a direct command to the computer but has a property that defines processing of the computer).

In addition, although the hardware entity is formed by executing a predetermined program in a computer in this mode, at least some of the processing contents may be implemented by hardware.

With regard to the above embodiment, the following supplements are further disclosed.

### (Supplementary Note 1)

An image caption generation model learning apparatus including:
a memory; and
at least one processor connected to the memory,
in which
the processor
uses, as inputs, pair data of an image that is learning data for image caption generation and text data that is a caption describing the image and pair data of a first language text and a second language text that are machine translation data; and
learns an image parameter that is a model parameter for image hidden information generation, a text parameter that is a model parameter for text hidden information generation, a crossmodal parameter that is a model parameter for crossmodal invariant information embedment, and an output parameter that is a model parameter for text generation.
   (Supplementary Note 2) A non-transitory storage medium storing a program executable by a computer to execute image caption generation model learning processing,
in which
the image caption generation model learning processing
uses, as inputs, pair data of an image that is learning data for image caption generation and text data that is a caption describing the image and pair data of a first language text and a second language text that are machine translation data; and
learns an image parameter that is a model parameter for image hidden information generation, a text parameter that is a model parameter for text hidden information generation, a crossmodal parameter that is a model parameter for crossmodal invariant information embedment, and an output parameter that is a model parameter for text generation.

### (Supplementary Note 3)

The image caption generation model learning apparatus according to supplementary note 1, in which
the processor
generates image hidden information from the image and the image parameter;
generates text hidden information from the first language text and the text parameter;
generates inter-crossmodal invariant information from the image hidden information or the text hidden information and the crossmodal parameter;
generates a text generation probability from the inter-crossmodal invariant information and the output parameter; and
estimates various model parameters such that a sum of a text generation probability of a text corresponding to a caption and a text generation probability of a text corresponding to a translation result of machine translation becomes maximum.

### (Supplementary Note 4)

The non-transitory storage medium according to supplementary note 2, in which
the image caption generation model learning processing
generates image hidden information from the image and the image parameter;
generates text hidden information from the first language text and the text parameter;
generates inter-crossmodal invariant information from the image hidden information or the text hidden information and the crossmodal parameter;
generates a text generation probability from the inter-crossmodal invariant information and the output parameter; and
estimates various model parameters such that a sum of a text generation probability of a text corresponding to a caption and a text generation probability of a text corresponding to a translation result of machine translation becomes maximum.

### (Supplementary Note 5)

An image caption generation apparatus including:
a memory; and
at least one processor connected to the memory,
in which
the processor
generates a caption describing an input image based on an image parameter that is model parameter for image hidden information generation learned by using, as inputs, pair data of an image that is learning data for image caption generation and text data that is a caption describing the image and pair data of a first language text and a second language text that are machine translation data, a crossmodal parameter that is a model parameter for crossmodal invariant information embedment, and an output parameter that is a model parameter for text generation.

### (Supplementary Note 6)

A non-transitory storage medium storing a program executable by a computer to execute image caption generation processing, the image caption generation processing
generates a caption describing an input image based on an image parameter that is model parameter for image hidden information generation learned by using, as inputs, pair data of an image that is learning data for image caption generation and text data that is a caption describing the image and pair data of a first language text and a second language text that are machine translation data, a crossmodal parameter that is a model parameter for crossmodal invariant information embedment, and an output parameter that is a model parameter for text generation.

### (Supplementary Note 7)

The image caption generation apparatus according to supplementary note 5, in which
the processor
generates image hidden information from an image and the image parameter;
generates inter-crossmodal invariant information from the image hidden information and the crossmodal parameter; and
generates a text generation probability from the inter-crossmodal invariant information and the output parameter and generates a text serving as the caption of the image.

### (Supplementary Note 8)

The non-transitory storage medium according to supplementary note 6, in which
the image caption generation processing
generates image hidden information from an image and the image parameter;
generates inter-crossmodal invariant information from the image hidden information and the crossmodal parameter; and
generates a text generation probability from the inter-crossmodal invariant information and the output parameter and generates a text serving as the caption of the image.

1. An image caption generation model learning apparatus comprising:
processing circuitry configured to
use, as inputs, pair data of an image that is learning data for image caption generation and text data that is a caption describing the image and pair data of a first language text and a second language text that are machine translation data; and
learn an image parameter that is a model parameter for image hidden information generation, a text parameter that is a model parameter for text hidden information generation, a crossmodal parameter that is a model parameter for crossmodal invariant information embedment, and an output parameter that is a model parameter for text generation.

2. The image caption generation model learning apparatus according to claim 1,
the processing circuitry configured to
generate image hidden information from the image and the image parameter;
generate text hidden information from the first language text and the text parameter;
generate inter-crossmodal invariant information from the image hidden information or the text hidden information and the crossmodal parameter;
generate a text generation probability from the inter-crossmodal invariant information and the output parameter; and
estimate various model parameters such that a sum of a text generation probability of a text corresponding to a caption and a text generation probability of a text corresponding to a translation result of machine translation becomes maximum.

3. An image caption generation apparatus comprising:
processing circuitry configured to
generate a caption describing an input image based on an image parameter that is model parameter for image hidden information generation learned by using, as inputs, pair data of an image that is learning data for image caption generation and text data that is a caption describing the image and pair data of a first language text and a second language text that are machine translation data, a crossmodal parameter that is a model parameter for crossmodal invariant information embedment, and an output parameter that is a model parameter for text generation.

4. The image caption generation apparatus according to claim 3,
the processing circuitry configured to
generate image hidden information from an image and the image parameter;
generate inter-crossmodal invariant information from the image hidden information and the crossmodal parameter; and
generate a text generation probability from the inter-crossmodal invariant information and the output parameter and generates a text serving as the caption of the image.

5. An image caption generation model learning method executed by an image caption generation model learning apparatus, the image caption generation model learning method comprising:
using, as inputs, pair data of an image that is learning data for image caption generation and text data that is a caption describing the image and pair data of a first language text and a second language text that are machine translation data; and
learning an image parameter that is a model parameter for image hidden information generation, a text parameter that is a model parameter for text hidden information generation, a crossmodal parameter that is a model parameter for crossmodal invariant information embedment, and an output parameter that is a model parameter for text generation.

6. An image caption generation method executed by an image caption generation apparatus, the image caption generation method comprising:
generating a caption describing an input image based on an image parameter that is model parameter for image hidden information generation learned by using, as inputs, pair data of an image that is learning data for image caption generation and text data that is a caption describing the image and pair data of a first language text and a second language text that are machine translation data, a crossmodal parameter that is a model parameter for crossmodal invariant information embedment, and an output parameter that is a model parameter for text generation.

7. A non-transitory computer readable medium storing a computer program for causing a computer to function as the image caption generation model learning apparatus according to claim 1.

8. A non-transitory computer readable medium storing a computer program for causing a computer to function as the image caption generation apparatus according to claim 3.
